(19) United States
(12) Patent Application Publication
(10) Pub. No.: US 2012/0306972 A1
(43) Pub. Date: Dec. 6, 2012

(54) INJECTION MOLDING METHOD, INJECTION-MOLDED PRODUCT, OPTICAL ELEMENT, OPTICAL PRISM, INK TANK, RECORDING DEVICE, AND INJECTION MOLD

(75) Inventors: Kei Yokota, Yamagata-mura (JP); Keiichi Shiohara, Matsumoto-shi (JP)

(73) Assignee: SEIKO EPSON CORPORATION, Tokyo (JP)

(21) Appl. No.: 13/489,131

(22) Filed: Jun. 5, 2012

(30) Foreign Application Priority Data
Jun. 6, 2011 (JP) 2011-126687

(51) Int. Cl. B29C 45/72; B32B 1/02; G02B 5/04; B32B 3/30; B29C 45/33; B41J 2/175

(52) U.S. Cl. 347/85; 264/328.7; 359/831; 428/156; 428/34.1

(57) ABSTRACT

There is provided an injection molding method in which a molten resin, which is injected into a molding space formed between a fixed side mold including a movable insert and a movable side mold, is cooled in a state in which a surface of the molten resin comes into contact with the movable insert and thereby the surface is solidified, and internal solidification of the molten resin is completed by cooling the molten resin in a state where the molten resin and the movable insert are separated from each other by moving the movable insert before the internal solidification of the molten resin, whose surface is solidified in a state in which the surface comes into contact with the movable insert, is completed.

### BACKGROUND

1. Technical Field

The present invention relates to an injection-molded product, for example, an optical prism or the like that has a high quality required surface in which high surface accuracy is required, an injection mold and an injection molding method to manufacture the injection-molded product.

2. Related Art

In the related art, for example, as an injection molding method of manufacturing an injection-molded product such as an optical prism that has a high quality required surface in which high surface accuracy (flatness) is required, an injection molding method disclosed in JP-A-2000-108185 may be exemplified.

In the injection molding method disclosed in JP-A-2000-108185, within a time when a molten resin injected and filled in a molding space is flowable, a molten resin is further injected while a mold is opened or after the mold is opened. Then, after entering a mold closed state, the mold is slightly opened to form a gap between a surface of the injection-molded product and the mold, and the mold is maintained in this state for a given time. Furthermore, within a time when the molten resin on a surface side of the injection-molded product is flowable, the mold is made to enter a mold closed state.

However, in the injection molding method disclosed in JP-A-2000-108185, since the entirety of the mold is opened or closed within a time when the molten resin injected and filled in a mold cavity is flowable, it is difficult to further suppress sinking, which occurs in the high quality required surface in which high surface accuracy is required compared to other surfaces.

### SUMMARY

An advantage of some aspects of the invention is to suppress sinking that occurs in a high quality required surface more compared to sinking that occurs in a surface in which required surface accuracy is low, in an injection-molded product having the high quality required surface in which high surface accuracy is required and the surface in which required surface accuracy is lower than that of the high quality required surface.

According to a first aspect of the invention, there is provided an injection molding method. The method includes: injecting a molten resin (for example, a molten resin R in FIG. 2) into a molding space, which is formed in a mold closed state, between a pair of molds including a movable insert (for example, a movable insert 6 in FIG. 1) that is mounted in at least one of the pair of molds (for example, a fixed side mold 2 and a movable side mold 4 in FIG. 1) in which mold opening and mold closing are possible; primarily cooling the molten resin, which is injected into the molding space in the injecting of the molten resin, in a state in which a surface of the molten resin comes into contact with the movable insert to solidify the surface; separating the movable insert from the molten resin by moving the movable insert before internal solidification of the molten resin (for example, a molten resin R in FIG. 3), whose surface is solidified in a state in which the surface comes into contact with the movable insert in the primarily cooling of the molten resin, is completed; and secondarily cooling the molten resin to complete the internal solidification in a state in which the molten resin and the movable insert are separated from each other in the separating of the movable insert.

According to this configuration, when the movable insert is made to move in the separating of the movable insert, in the secondarily cooling of the molten resin, cooling by heat exchange with the mold at a portion, which is separated from the movable insert until the internal solidification is completed, of the molten resin whose surface is solidified is inhibited compared to cooling by heat exchange with the mold at other portions of the molten resin.

Therefore, the progress of the solidification in the inside of the molten resin whose surface is solidified becomes slow at a portion that is close to the surface separated from the movable insert compared to portions that are close to surfaces that come into contact with a molding space forming section other than the movable insert.

As a result, shrinkage that occurs in the molten resin whose surface is solidified when the internal solidification is in progress may be concentrated on the portion that is close to the surface separated from the movable insert. Therefore, in the molten resin whose internal solidification is in progress, sinking that occurs in the surface that comes into contact with the molding space forming section other than the movable insert may be suppressed.

In addition, in the injection molding method, in the separating of the movable insert, the movable insert may be made to move before the internal solidification of the molten resin, whose surface is solidified to a state in which an injected shape in the molding space is maintained even when the movable insert is separated, is completed.

According to this configuration, even when the movable insert is made to move in the separating of the insert before the internal solidification of the molten resin whose surface is solidified is completed, and thereby the molten resin whose internal solidification is not completed and the movable insert are separated from each other, the shape of the molten resin which is injected to the molding space and whose surface is solidified may be maintained.

Therefore, in the molten resin whose internal solidification is in progress, sinking that occurs in the surface that comes into contact with the molding space forming section other than the movable insert may be suppressed, and a variation in a shape of an injection-molded product that is formed of the molten resin whose internal solidification is completed may be suppressed.

In addition, according to a second aspect of the invention, there is provided an injection-molded product that is an optical element including an optical prism. According to this configuration, a control of light in the optical element may be reliably performed.

In addition, according to a third aspect of the invention, there is provided an ink tank including the optical prism according to the second aspect of the invention. According to this configuration, accuracy of detecting whether or not ink in the ink tank is present may be increased.

In addition, according to a fourth aspect of the invention, there is provided a recording device including the ink tank according the third aspect of the invention. According to this configuration, accuracy of detecting whether or not ink in the ink tank is present may be increased.

According to a fifth aspect of the invention, there is provided an injection-molded product (for example, an injection-molded product P in FIG. 4) including a high quality required surface (for example, a high quality required surface P1 in FIG. 4) and a high quality not-required surface (for example, a high quality not-required surface P2 in FIG. 4) that has surface accuracy lower than that of the high quality required surface. The injection-molded product is formed of a solidified molten resin. In a case where an amount of shrinkage accompanying the solidification of the molten resin with respect to the maximum thickness of the high quality required surface is set to S1, and an amount of shrinkage accompanying the solidification of the molten resin with respect to the maximum thickness of the high quality not-required surface is set to S2, a conditional expression of S1≦S2/2 is satisfied.

According to this configuration, an amount of depression of a sink mark that is formed in the high quality required surface in which high surface accuracy is required may be half or less of an amount of depression of a sink mark that is formed in the high quality not-required surface in which required surface accuracy is lower than that of the high quality required surface.

Therefore, with respect to the entirety of the injection-molded product, the sinking that occurs due to the solidification of the molten resin is concentrated on the high quality not-required surface and thereby the sinking that occurs in the high quality required surface may be suppressed.

As a result, a decrease in surface accuracy that is required for the high quality required surface may be suppressed, and therefore a decrease in the quality required for the injection-molded product may be suppressed.

In addition, according to a sixth aspect of the invention, there is provided an injection mold (for example, an injection mold 1 in FIG. 1). The injection mold includes: a movable insert that is mounted in at least one of a pair of molds in which mold opening and mold closing are possible; a molding space forming section (for example, an inner wall surface of a fixed side opening portion 12, a surface, which is opposite to the fixed side opening portion 12, of a movable side mold 4, and an inclined surface of a movable insert 6 in FIG. 1) that forms a molding space, which is formed between the pair of molds including the movable insert in the mold closed state and into which a molten resin is injected; and an insert driving section (for example, an insert driving section 8 in FIG. 1) that moves the movable insert before internal solidification of the molten resin, which is injected into the molding space and whose surface is solidified in a state in which the molten resin comes into contact with the movable insert, is completed, and separates the molten resin whose internal solidification is not completed and the movable insert from each other.

According to this configuration, when the movable insert is moved by the insert driving section, cooling by heat exchange with the mold at a portion, which is separated from the movable insert until the internal solidification is completed, of the molten resin whose surface is solidified is inhibited compared to cooling by heat exchange with the mold at other portions of the molten resin.

Therefore, the progress of the solidification in the inside of the molten resin whose surface is solidified becomes slow at a portion that is close to the surface separated from the movable insert compared to portions that are close to surfaces that come into contact with a molding space forming section other than the movable insert.

As a result, shrinkage that occurs in the molten resin whose surface is solidified when the internal solidification is in progress may be concentrated on the portion that is close to the surface separated from the movable insert. Therefore, in the molten resin whose internal solidification is in progress, sinking that occurs in the surface that comes into contact with the molding space forming section other than the movable insert may be suppressed.

In the injection mold, the insert driving section may move the movable insert before the internal solidification of the molten resin, whose surface is solidified to a state in which an injected shape in the molding space is maintained even when the movable insert is separated, is completed.

According to this configuration, even when the movable insert is moved by the insert driving section before the internal solidification of the molten resin whose surface is solidified is completed, and thereby the molten resin whose internal solidification is not completed and the movable insert are separated from each other, the shape of the molten resin which is injected to the molding space and whose surface is solidified may be maintained.

Therefore, in the molten resin whose internal solidification is in progress, sinking that occurs in the surface that comes into contact with the molding space forming section other than the movable insert may be suppressed, and a variation in a shape of an injection-molded product that is formed of the molten resin whose internal solidification is completed may be suppressed.

### BRIEF DESCRIPTION OF THE DRAWINGS

The invention will be described with reference to the accompanying drawings, wherein like numbers reference like elements.

FIG. 1 is a view illustrating a schematic configuration of an injection mold.

FIG. 2 is a view illustrating a schematic configuration of the injection mold in a state in which a molten resin is injected into a molding space in an injection process.

FIG. 3 is a view illustrating a schematic configuration of the injection mold in a state in which a movable insert is separated from the molten resin whose surface is solidified in an insert separating process.

FIG. 4 is a view illustrating a schematic configuration of the injection mold in a state in which a fixed side mold and a movable side mold are in an opened state in an ejection process.

FIG. 5 is a view illustrating a configuration of an injection-molded product.

FIG. 6 is a view illustrating a modification example of a first embodiment of the invention.

FIG. 7 is a view illustrating a modification example of the first embodiment of the invention.

FIGS. 8A and 8B are views illustrating an ink tank including an optical prism, and FIG. 8C is an external perspective view of an ink jet printer.

### DESCRIPTION OF EXEMPLARY EMBODIMENTS

Hereinafter, embodiments of an injection-molded product, an injection mold, and an injection molding method according to the invention will be described with reference the attached drawings.

### First Embodiment

### Configuration

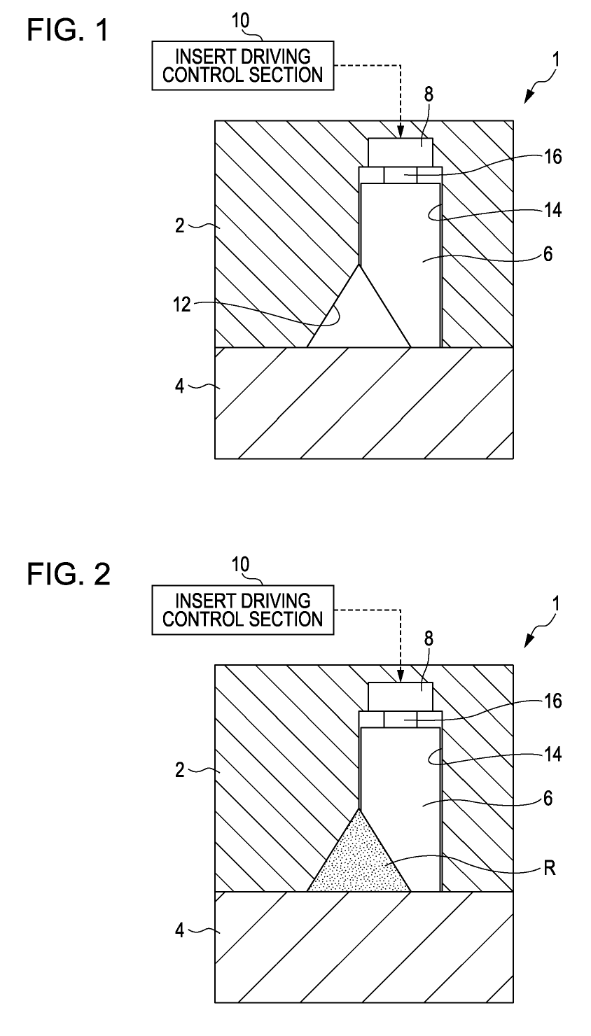

First, a configuration of the injection mold in the first embodiment will be described with reference to FIG. 1.

FIG. 1 shows a schematic configuration of the injection mold 1 and is a cross-sectional view of the injection mold 1.

The injection mold 1 shown in FIG. 1 is a device that injects a molten resin into a molding space (cavity), which is formed between a pair of molds in a case where the pair of molds in which mold opening and mold closing are possible is in a mold closed state, and solidifies the injected molten resin to manufacture an injection-molded product. In addition, a description with respect to the molding space will be made later.

Here, in the first embodiment, a description will be made with respect to a case in which the injection-molded product has light transmission properties and a cross-sectional shape thereof is a prism shape of an equilateral triangle or substantially equilateral triangle as an example. In this case, the injection-molded product is, for example, a part, which is provided in an ink cartridge provided in a printing machine (printer), and through which light is transmitted to detect an ink residual quantity.

Therefore, in the first embodiment, a description will be made with respect to a case in which a transparent resin is used as the molten resin material. In addition, the configurations of the injection-molded product and the molten resin material are not limited to the above-described configuration.

Here, as the molten resin material, for example, resins such as ABS (Acrylonitrile Butadiene Styrene copolymer synthetic resin), PS (polystyrene), AS (Acrylonitrile Styrene copolymer compound), PMMA (Poly Methyl Methacrylate), PC (Polycarbonate), and a cyclic olefin-based resin may be used.

As described above, in a case where the injection-molded product is a light transmissive part, it is required that in the injection-molded product, a surface (a functional surface), which makes up a light incident surface or a light emitting surface, or both of them, is a surface in which a degree of variation from a desired shape is small. In addition, this is true of a reflective surface in a case where the reflective surface is present. This represents a surface in which a degree of variation in unevenness, surface roughness, or the like is small is required for a surface (a functional surface), in a case where for example, a flat surface with a desired shape is set in the surface (the functional surface) of the injection-molded product.

Therefore, in the first embodiment, a description will be made with respect to a case in which the injection-molded product is set as an optical prism that is formed of a solidified molten resin and that has a high quality required surface that is a functional surface in which high surface accuracy is required, and a high quality not-required surface in which surface accuracy is lower than that of the high quality required surface.

In a case where the functional surface that functions as an optical prism has two surfaces of an incident surface and an emitting surface, it is preferable that the optical prism be configured in such a manner that the two surfaces become the high quality required surfaces.

In addition, in a case where the functional surface, which functions as the optical prism, has three surfaces of an incident surface, a reflective surface, and an emitting surface, for example, a configuration in which light is incident to one surface, is reflected on remaining two surfaces, and is emitted from the same surface as the incident surface may be considered. In this case, it is preferable that the two surfaces that reflect light be formed as the high quality required surface.

According to this configuration, the path of the light may be reliably controlled.

As shown in FIG. 1, the injection mold 1 includes a fixed side mold 2 and a movable side mold 4 as the above-described pair of molds. In addition to this, the injection mold 1 includes a movable insert 6, an insert driving section 8, and an insert driving control section 10. In addition, in FIG. 1, the injection mold 1 is shown in a mold closed state.

The fixed side mold 2 is attached to a fixed plate (not shown), which maintains the injection mold 1, using a bolt or the like, and a fixed side opening portion 12, an insert displacement cavity portion 14, and a resin passage (not shown) are formed inside the fixed side mold 2.

The fixed side opening portion 12 is a space into which a molten resin is filled, and is opened in a surface (in FIG. 1, a lower side surface), which is opposite to the movable side mold 4, of the fixed side mold 2.

The insert displacement cavity portion 14 is a space in which the movable insert 6 may be disposed and in which the movable insert 6 disposed at the inside thereof may move, and is formed to be continuous to the fixed side opening portion 12.

The resin passage is formed so that the molten resin may flow therethrough. In addition, one end side of the resin passage is opened toward the fixed side opening portion 12, and the other end side of the resin passage communicates with a resin injecting device (not shown).

The resin injecting device is a device that weights and plasticizes the molten resin material (solid resin material or the like) in response to the volume and shape of the injection-molded product, and injects the weighted and plasticized molten resin to the resin passage.

In addition, the fixed side mold 2 includes an ejector pin (not shown) that may protrude into the fixed side opening portion 12. In a normal state, this ejector pin does not protrude into the fixed side opening portion 12.

In addition, as a specific configuration example of operating the ejector pin, for example, a configuration in which an upper side plate in which the ejector pin and a return pin in the related art are provided, and a lower side plate that presses and fixes the ejector pin and the return pin are provided. In this case, the ejector pin is made to protrude into the fixed side opening portion 12 by the ejector device in the related art, which is provided in the injection mold 1, and thereby the injection-molded product that is solidified in the fixed side opening portion 12 is ejected therefrom.

The movable side mold 4 is connected to a driving mechanism (not shown), and is formed to move in a vertical direction (a vertical direction in FIG. 1) using a driving force that is generated by the driving mechanism. In addition, the driving mechanism includes, for example, a mechanical type using a rotational movement of a motor, or a hydraulic type in which pressure is applied to a liquid such as oil.

The movable insert 6 is formed in a single columnar shape having one inclined surface, and is disposed to be movable in the insert displacement cavity portion 14 in a state in which the inclined surface is opposite to the fixed side opening portion 12. Here, the moving direction of the movable insert 6 in the insert displacement cavity portion 14 is a direction to be close to the movable side mold 4 or a direction to be distant from the movable side mold 4. In addition, in the first embodiment, the injection mold 1 is configured to have only one movable insert 6 as an example.

Here, in the first embodiment, as described above, the injection-molded product is configured to have a high quality required surface and a high quality not-required surface. The cross-sectional shape of the injection-molded product is set to a prism shape of an equilateral triangle or a substantially equilateral triangle.

Therefore, in the first embodiment, the fixed side mold 2, the movable side mold 4, and the movable insert 6 are formed in such a manner that in a case where the pair of molds in which mold opening and mold closing are possible, that is, the fixed side mold 2 and the movable side mold 4 are in a mold closed state, a cross-sectional shape of a molding space corresponds to a prism shape of an equilateral triangle or a substantially equilateral triangle. Wherein the molding space is formed between an inner wall surface of the fixed side opening portion 12, a surface, which is opposite to the fixed side opening portion 12, of the movable side mold 4, and a surface, which is opposite to the fixed side opening portion 12, of the movable insert 6.

That is, in the first embodiment, the inner wall surface of the fixed side opening portion 12, the surface, which is opposite to the fixed side opening portion 12 of the movable side mold 4, and the inclined surface of the movable insert 6 form the molding space forming section that forms the molding space. Therefore, the injection mold 1 according to the first embodiment includes the injection space forming section that forms the injection space which is formed between the fixed side mold 2 including the movable insert 6 and the movable side mold 4 in a mold closed state and into which the molten resin is injected.

Here, in the first embodiment, among surfaces of the injection-molded product, a surface that is opposite to the movable side mold 4 in the molding space is set as the high quality required surface that is a functional surface in which a flat surface with a desired shape is set, a degree of variation in unevenness, surface roughness, or the like is small, and high surface accuracy is required. Along with this, in the first embodiment, among surfaces of the injection-molded product, a surface that is opposite to the movable insert 6 in the molding space is set as the high quality not-required surface in which surface accuracy is lower than that of the high quality required surface.

In addition, in this first embodiment, a description will be made with respect to a case in which the inclined surface of the movable insert 6 is formed as a flat surface as an example.

The insert driving section 8 is formed using, for example, an air cylinder, a hydraulic cylinder, a motor, or the like, and is embedded in the fixed side mold 2. In addition, the insert driving section 8 may be configured to be mounted on an external surface of the fixed side mold 2.

In addition, the insert driving section 8 is disposed to be movable in the insert displacement cavity portion 14, and includes an insert displacing member 16 that is connected to the movable insert 6. Here, a movement direction of the insert displacing member 16 in the insert displacement cavity portion 14 is a direction to be close to the movable side mold 4 and a direction to be distant from the movable side mold 4.

In addition, insert driving section 8 moves the insert displacing member 16 in response to an instruction value input from the insert driving control section 10, and moves the movable insert 6 in the insert displacement cavity portion 14. Here, processing (computation or the like) accompanying a control of moving the insert displacing member 16, that is, a control (a control of a moving timing, a moving velocity, a moving amount, or the like) of moving the movable insert 6 in the insert displacement cavity portion 14, is performed by the insert driving control section 10.

The insert driving control section 10 is formed by using, for example, a PC (Personal Computer), and calculates a moving timing or the like of the movable insert 6 in the insert displacement cavity portion 14 in response to a degree in which the molten resin is cooled and solidified. In addition, this calculated value is output to the insert driving section 8 as an instruction value.

Here, a degree in which the molten resin is cooled and solidified in response to physical properties (a glass transition point or the like) of the molten resin material or a shape size (thickness or the like) of the injection-molded product is stored in advance in the insert driving control section 10.

In addition, specifically, the degree in which the molten resin is cooled and solidified represents a surface solidification time that is necessary until a surface of the molten resin injected into the molding space is solidified, and a solidification completion time that is necessary until the internal solidification of the molten resin injected into the molding space is completed.

Here, in the first embodiment, the surface solidification time is a time taken until the surface of the molten resin injected into the molding space is solidified to a state in which a shape injected into the molding space is maintained even when the movable insert 6 is made to move so as to be separated from the molten resin injected into the molding space.

In addition to this, the insert driving control section 10 calculates the moving timing of the movable insert 6 or the like before the molten resin is injected into the molding space in order for the molten resin that is injected into the molding space to come into contact with the movable insert 6.

Furthermore, the insert driving control section 10 calculates the moving timing of the movable insert 6 or the like, in response to the stored surface solidification time and solidification completion time, in order to move the movable insert 6, and to separate the molten resin whose internal solidification is not completed and the movable insert 6 from each other before the internal solidification of the molten resin, which is injected into the molding space and whose surface is solidified in a state of being brought into contact with the movable insert 6.

Therefore, the insert driving section 8 to which an instruction value is input from the insert driving control section 10 moves the movable insert 6 and separates the molten resin whose internal solidification is not completed and the movable insert 6 from each other before the internal solidification of the molten resin, which is injected into the molding space and whose surface is solidified in a state of being brought into contact with the movable insert 6.

In addition, in the first embodiment, the insert driving section 8 to which an instruction value is input from the insert driving control section 10 moves the movable insert 6 before the internal solidification of the molten resin whose surface is solidified to a state in which the shape injected into molding space is maintained even when the movable insert 6 is separated.

Injection Molding Method

Next, a description will be made with respect to a process of manufacturing the injection-molded product by using the injection mold 1 having the above-described configuration with reference to FIGS. 2 to 4 while referring to FIG. 1.

In the first embodiment, when manufacturing the injection-molded product, an injection molding method including an injection process, a pressure maintaining process, a primary cooling process, an insert separating process, a secondary cooling process, and an ejection process is used.

Injection Process, Pressure Maintaining Process, Primary Cooling Process

Hereinafter, an operation of the injection mold 1 in the injection process, the pressure maintaining process, and the primary cooling process will be described. In addition, in the following description, it is assumed that the pair of molds in which the mold opening and the mold closing are possible, that is, the fixed side mold 2 and the movable side mold 4 are in a mold opened state.

In the injection process, first, the movable side mold 4 is made to move to the fixed side mold 2 side, and then the movable side mold 4 and the fixed side mold 2 are brought into contact with each other, and thereby as shown in FIG. 1, the fixed side mold 2 and the movable side mold 4 enter the mold closed state.

At this time, the insert driving control section 10 calculates an moving amount of the movable insert 6 so that the position of the movable insert 6 becomes a position at which the molding space has a shape corresponding to the injection-molded product. In addition, the insert driving control section 10 outputs the calculated moving amount to the insert driving section 8 as an instruction value, and the insert driving section 8 moves the movable insert 6, and thereby the shape of the molding space is set to a shape corresponding to the injection-molded product.

The movable side mold 4 and the movable insert 6 are made to move to set the molding space to a shape corresponding to the injection-molded product, and then as shown in FIG. 2, the weighted and plasticized molten resin R is injected into the molding space. Then, the injection process is terminated, and the process transitions to the pressure maintaining process. In addition, FIG. 2 shows a view illustrating a schematic configuration of the injection mold 1 in a state in which the molten resin is injected into the molding space in the injection process, and shows a cross-sectional view of the injection mold 1.

In the pressure maintaining process, the positions of the movable side mold 4 and the movable insert 6 are maintained, and in the molding space, the pressure of the molten resin R injected in the injection process is maintained. Then, the pressure maintaining process is terminated and the process transitions to the primary cooling process.

In the primary cooling process, the surface of the molten resin R, which is injected into the molding space in the injection and pressure maintaining processes, is cooled and solidified by a heat exchange operation between the fixed side mold 2 and the movable side mold 4 in a state of being brought into contact with the movable insert 6.

Insert Separating Process

Hereinafter, an operation of the injection mold 1 in the insert separating process will be described.

In the insert separating process, the movable insert 6 is made to move before the internal solidification of the molten resin R whose surface is solidified in a state of being brought into contact with the movable insert 6 in the primary cooling process is completed to separate the molten resin R and the movable insert 6 from each other.

Specifically, in the insert separating process, the insert driving control section 10 calculates the moving timing of the movable insert 6 or the like in response to the stored surface solidification time and solidification completion time in order to move the movable insert 6 and to separate the molten resin R whose internal solidification is not completed and the movable insert 6 from each other before the internal solidification of the molten resin R, which is injected into the molding space and whose surface is solidified, is completed.

When the value calculated by the insert driving control section 10 is output to the insert driving section 8 as an instruction value, the insert driving section 8 moves the insert displacing member 16 in response to the input instruction value to move the movable insert 6 in a direction to be distant from the movable side mold 4 in the insert displacement cavity portion 14.

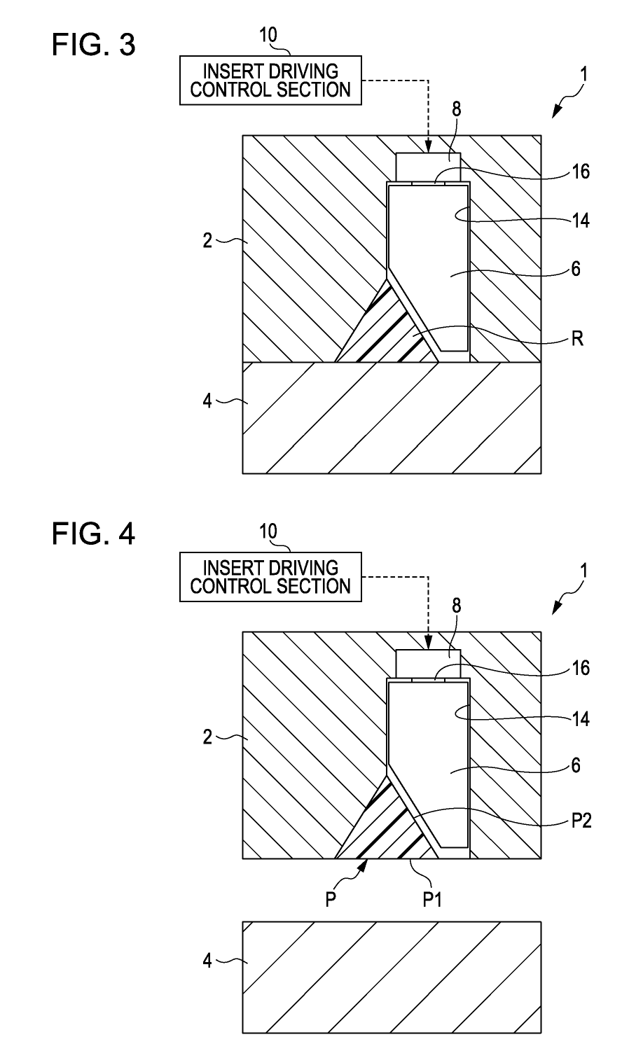

Therefore, as shown in FIG. 3, the movable insert 6 is separated from a portion, whose surface is solidified by being brought into contact with the movable insert 6, of the molten resin R in a state in which a surface thereof is solidified in the primary cooling process, that is, from a surface, which becomes a high quality not-required surface of the injection-molded product, of the molten resin R that is in a state of being solidified by the primary cooling process. In addition, FIG. 3 shows a view illustrating a schematic configuration of the injection mold 1 in a state in which the movable insert 6 is separated from the molten resin R whose surface is solidified in the insert separating process, and shows a cross-sectional view of the injection mold 1.

In addition, in the first embodiment, in the insert separating process, the movable insert 6 is made to move before the internal solidification of the molten resin R, whose surface is solidified to a state in which the shape injected to the injection space is maintained even when the movable insert 6 is separated, is completed.

After the molten resin R whose surface is solidified by the primary cooling process and whose internal solidification is not completed and the movable insert 6 are separated from each other, the position of the movable insert 6 is maintained. Then, the insert separating process is terminated and the process transitions to the secondary cooling process.

Secondary Cooling Process

Hereinafter, an operation of the injection mold 1 in the secondary cooling process will be described.

In the secondary cooling process, the fixed side mold 2 and the movable side mold 4 are made to enter a mold closed state, and in the insert separating process, a state in which the molten resin R whose surface is solidified and whose internal solidification is not completed and the movable insert 6 are maintained at separated positions is maintained with respect to the molten resin R whose surface is solidified until the internal solidification thereof is completed.

At this time, in the molten resin R whose surface is solidified, sinking occurs due to shrinkage that occurs when the internal solidification is in progress.

Here, in the above-described insert separating process, the movable insert 6, which comes into contact with a surface, which becomes the high quality not-required surface of the injection-molded product, of the molten resin R whose surface is solidified and whose internal solidification is not completed, is separated from the surface.

Therefore, in the secondary cooling process, cooling by heat exchange with the mold at a portion, which is separated from the movable insert 6 until the internal solidification is completed, of the molten resin whose surface is solidified, that is, a surface that becomes the high quality not-required surface of the injection-molded product, is inhibited compared to cooling by heat exchange with the mold (the movable side mold 4) at other portions of the molten resin, that is, surfaces that become the high quality required surface of the injection-molded product.

Therefore, the progress of the solidification in the inside of the molten resin R whose surface is solidified becomes slow at a portion that is close to the surface separated from the movable insert 6, that is, a portion close to the surface that becomes the high quality not-required surface of the injection-molded product compared to portions that are close to surfaces that come into contact with a molding space forming section other than the movable insert 6, that is, portions close to surfaces that become the high quality required surface of the injection-molded product.

As a result, shrinkage that occurs in the molten resin R whose surface is solidified when the internal solidification is in progress may be concentrated on the portion close to the surface separated from the movable insert 6, that is, the portion close to the surface that becomes the high quality not-required surface of the injection-molded product.

As described above, since the sinking, which occurs in the surface, which comes into contact with the molding space forming section other than the movable insert 6, of the molten resin R whose internal solidification is in progress, that is, the high quality required surface of the injection-molded product, may be suppressed, the sinking that occurs in the high quality required surface may be suppressed more compared to the sinking that occurs in the high quality not-required surface.

Here, in a case where the conditions (molding conditions) of the injection molding are fixed, when being converted into a shrinkage rate of the injection-molded product, unevenness in the amount of sinking may be in the order of ±0.01[%].

In this manner, when the internal solidification of the molten resin R whose surface is solidified is completed and thereby an injection-molded product is formed, the injection-molded product in which an amount of depression of a sink mark formed in the high quality required surface is smaller than an amount of depression of a sink mark formed in the high quality not-required surface is formed. When the injection-molded product is formed, the secondary cooling process is terminated and the process transitions to the ejection process.

That is, since the amount of depression of the sink mark that is formed in the high quality not-required surface of the injection-molded product formed of the solidified molten resin R is larger than the amount of depression of a sink mark that is formed in the high quality required surface, surface accuracy of the high quality not-required surface becomes lower than that of the high quality required surface.

Here, the “sink mark” is a shallow mark formed in the surface of the injection-molded product, and is a portion that is formed when the surface of the injection-molded product is depressed due to local internal shrinkage that occurs as the molten resin injected into the molding space is cooled.

Ejection Process

Hereinafter, an operation of the injection mold 1 in the ejection process will be described.

In the ejection process, first, with respect to the fixed side mold 2 and the movable side mold 4 that are in a mold closed state, the movable side mold 4 is made to move in a direction to be distant from the fixed side mold 2, and thereby as shown in FIG. 4, the movable side mold 4 and the fixed side mold 2 are separated, and fixed side mold 2 and the movable side mold 4 enter the mold opened state. In addition, FIG. 4 shows a schematic configuration of the injection mold 1 in a state in which the fixed side mold 2 and the movable side mold 4 are made to enter the mold opened state in the ejection process, and shows a cross-sectional view of the injection mold 1.

In addition, after the fixed side mold 2 and the movable side mold 4 are made to enter the mold opened state, an ejector pin is made to protrude into the inside of the fixed side opening portion 12, an injection-molded product P that is solidified in the fixed side opening portion 12 (in the molding space) is ejected, and then the manufacturing of the injection-molded product P is terminated. In addition, in FIG. 4, a symbol “P1” is given to represent the high quality required surface of the injection-molded product P, and a symbol “P2” is given to represent the high quality not-required surface of the injection-molded product P.

In this manner, according to the injection molding method of the first embodiment, even when the movable insert 6 is made to move in the insert separating process before the internal solidification of the molten resin R, whose surface is solidified, is completed, and thereby the molten resin R whose internal solidification is not completed and the movable insert 6 are separated from each other, the shape of the molten resin R, which is injected into the molding space and whose surface is solidified, may be maintained.

Therefore, in the molten resin R in which the internal solidification is in progress, the sinking, which occurs in the high quality required surface P1, may be suppressed, and a variation in a shape of the injection-molded product P that is formed of the molten resin R in which the internal solidification is completed may be suppressed.

Configuration of Injection-Molded Product P

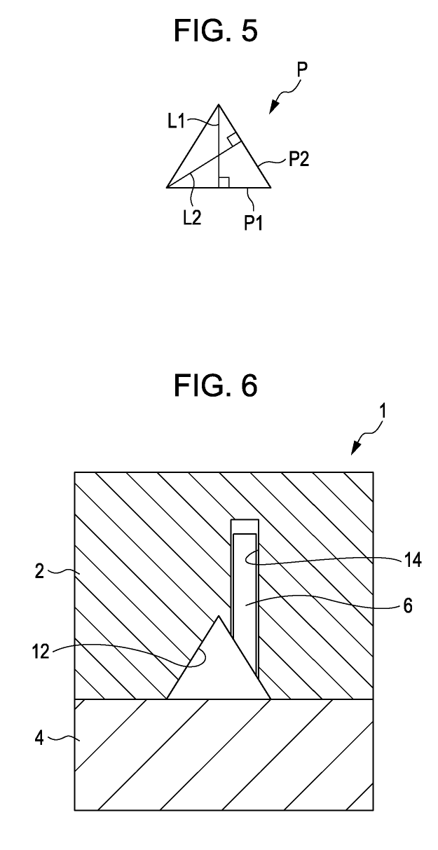

Next, a description will be made with respect to a configuration of the injection-molded product P that is manufactured by using the injection mold 1 and injection molding method having a configuration described above with reference to FIG. 5 while referring to FIGS. 1 to 4.

FIG. 5 shows a view illustrating a configuration of the injection-molded product P.

As described above, the injection-molded product P is formed of the molten resin R whose surface solidification and internal solidification are completed, and as shown in FIG. 5, has the high quality required surface P1 and the high quality not-required surface P2 in which surface accuracy is lower than that of the high quality required surface P1.

Here, in a case where an amount of shrinkage accompanying the solidification of the molten resin R with respect to the maximum thickness of the high quality required surface P1 is set to S1, and an amount of shrinkage accompanying the solidification of the molten resin R with respect to the maximum thickness of the high quality not-required surface P2 is set to S2, the following conditional expression (1) is established.

S1≦S2/2 (1)

In addition, as shown in FIG. 5, the maximum thickness of the high quality required surface P1 corresponds to the maximum length of a perpendicular line L1 that extends from the high quality required surface P1 to the inside of the injection-molded product P, and the maximum thickness of the high quality not-required surface P2 corresponds to the maximum length of a perpendicular line L2 that extends from the high quality not-required surface P2 into the injection-molded P.

As described above, in the injection-molded product P according to the first embodiment, the amount of depression of the sink mark formed in the high quality required surface P1 may be half or less of the amount of depression of the sink mark formed in the high quality not-required surface P2 in which surface accuracy lower than that of the high quality required surface P1 is required.

Therefore, with respect to the entirety of the injection-molded product P, the sinking that occurs due to the solidification of the molten resin R is concentrated on the high quality not-required surface P2 and thereby the sinking that occurs in the high quality required surface P1 may be suppressed.

As a result, a decrease in surface accuracy that is required for the high quality required surface P1 may be suppressed, and therefore a decrease in quality, which is required for the injection-molded product P, such as flatness required for the optical prism, may be suppressed.

In addition, as described above, according to the injection mold 1 of the first embodiment, when the movable insert 6 is moved by the insert driving section 8, in the molten resin R whose surface is solidified, cooling by heat exchange with the mold at a portion, which is separated from the movable insert 6 until the internal solidification is completed, of the molten resin R whose surface is solidified is inhibited compared to cooling by heat exchange with the mold at other portions of the molten resin R.

Therefore, the progress of the solidification in the inside of the molten resin R whose surface is solidified becomes slow at a portion that is close to the surface separated from the movable insert 6, that is, a portion close to the surface that becomes the high quality not-required surface of the injection-molded product compared to portions that are close to surfaces that come into contact with a molding space forming section other than the movable insert 6, that is, portions close to surfaces that become the high quality required surface of the injection-molded product.

As a result, shrinkage that occurs in the molten resin R whose surface is solidified when the internal solidification is in progress may be concentrated on the portion close to the surface separated from the movable insert 6, that is, the portion close to the surface that becomes the high quality not-required surface P2 of the injection-molded product P.

As described above, since the sinking, which occurs in the surface, which comes into contact with the molding space forming section other than the movable insert 6, of the molten resin R whose internal solidification is in progress, that is, the high quality required surface P1 of the injection-molded product P, may be suppressed, the sinking that occurs in the high quality required surface P1 may be suppressed more compared to the sinking that occurs in the high quality not-required surface P2.

According to the injection mold 1 of the first embodiment, even when the movable insert 6 is made to move by the insert driving section 8 before the internal solidification of the molten resin R whose surface is solidified is completed, and thereby the molten resin R whose internal solidification is not completed and the movable insert 6 are separated from each other, the shape of the molten resin R, which is injected into the molding space and whose surface is solidified, may be maintained.

Therefore, in the molten resin R in which the internal solidification is in progress, the sinking, which occurs in the high quality required surface P1 of the injection-molded product P, may be suppressed, and a variation in a shape of the injection-molded product P that is formed of the molten resin R in which the internal solidification is completed may be suppressed.

In addition, according to the injection mold 1 of the first embodiment, when the movable insert 6 is moved by the insert driving section 8, the sinking that occurs in the high quality required surface P1 of the injection-molded product P may be suppressed.

Therefore, for example, the configuration of the injection mold 1 may be simplified compared to a case in which a temperature control section (a heater or the like) is embedded in the movable insert 6 and cooling of the surface, which becomes the high quality not-required surface P2, of the injection-molded product P is inhibited.

In addition to this, since the constituent part such as the temperature control section is not embedded in the movable insert 6, even when the injection-molded product P is a small part, the sinking that occurs in the high quality required surface P1 of the injection-molded product P may be suppressed.

In addition, since the sinking that occurs in the high quality required surface P1 of the injection-molded product P may be suppressed by controlling a moving state of the movable insert 6, for example, a moving time of the movable insert 6, or the like, the number of processes necessary for the control becomes small and the configuration of the injection mold 1 may be simplified.

### MODIFICATION EXAMPLE

Hereinafter, a modification example of the first embodiment will be described.

In the first embodiment, the movable insert 6 is configured in such a manner that the surface (inclined surface), which is opposite to the fixed side opening portion 12, of the movable insert 6 is opposite to the entirety of the high quality not-required surface, but it is not limited thereto. That is, for example, as shown in FIG. 6, the movable insert 6 may be configured in such a manner that the surface, which is opposite to the fixed side opening portion 12, of the movable insert 6 is opposite to only a part of the high quality not-required surface. In addition, FIG. 6 is a view illustrating the modification example of the first embodiment.

In this case, for example, as shown in FIG. 6, the movable insert 6 is configured in such a manner that the surface, which is opposite to the fixed side opening portion 12, of the movable insert 6 is opposite to the center of the high quality not-required and the periphery of the center. This is because in the center of the high quality not-required surface and the periphery of the center, the amount of shrinkage, which occurs in the molten resin R in which the internal solidification progresses after the surface is solidified, is large compared to the outer circumference side of the high quality not-required surface.

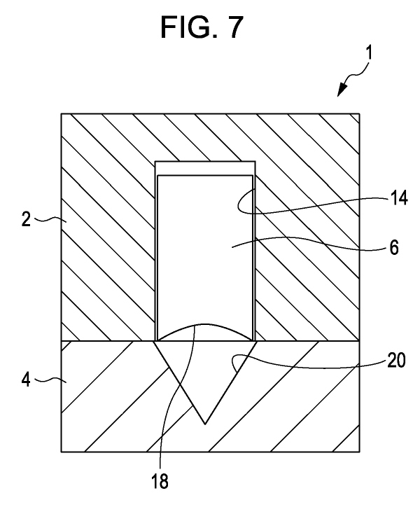

In addition, in the first embodiment, the surface, which is opposite to the fixed side opening portion 12, of the movable insert 6 is formed as a flat surface, but it is not limited to thereto. That is, for example, as shown in FIG. 7, the surface, which is opposite to the fixed side opening portion 12, of the movable insert 6 may be formed with a curved surface 18 in which a central portion is most depressed and is continuous. In addition, FIG. 7 shows a view illustrating the modification example of the first embodiment.

In this case, for example, as shown in FIG. 7, the fixed side mold 2 is configured not to have the fixed side opening portion 12 formed therein, and the movable side mold 4 is configured to have a movable side opening portion 20 and a resin passage (not shown) formed therein. In addition, in a case where the surface, which is opposite to the fixed side opening portion 12, of the movable insert 6 is formed as a concave portion such as the curved surface 18, since the molten resin R that is injected into the molding space has a shape that comes into contact with the curved surface 18 in the molding space, the high quality not-required surface has a shape that swells (protrudes) to the insert 6 side rather than a flat surface. Therefore, even when the shrinkage, which occurs in the molten resin R when the internal solidification progresses during the secondary cooling process, is concentrated on a portion close to the surface that becomes the high quality not-required surface, the state of the high quality not-required surface that is shrunk becomes close to the flat surface.

In addition, in the first embodiment, the injection mold 1 is configured to include only one movable insert 6, but it is not limited thereto. In a case where the injection-molded product P is configured to have a plurality of high quality not-required surfaces, the injection mold 1 may be configured to have a plurality of the movable inserts 6. In this case, the injection mold 1 may be configured in such a manner that the plurality of the movable insert 6 individually include the insert driving section 8 and the insert driving control section 10. That is, injection mold 1 may include a plurality of the insert driving sections 8 and insert driving control sections 10.

As described above, in a case where the injection-molded product P is configured to have a plurality of high quality not-required surfaces, for example, the high quality required surface is one in number, in the plurality of high quality not-required surfaces, the shrinkage of the molten resin R whose internal solidification is in progress may be concentrated on portions that are close to surfaces that become these high quality not-required surfaces. Therefore, the sinking that occurs in the surface that becomes the high quality required surface may be further suppressed.

In addition, in the first embodiment, the fixed side mold 2 has a configuration in which the movable insert 6 is mounted, but it is not limited thereto. The movable insert 6 may be mounted in the movable side mold 4. In addition, the movable insert 6 may be mounted in the fixed side mold 2 and the movable side mold 4, respectively.

In addition, in the first embodiment, the movable insert 6 is configured in such a manner that only one surface thereof is opposite to the fixed side opening portion 12, but it is not limited thereto. That is, for example, in a case where the injection-molded product P is configured to have two high quality not-required surfaces that are adjacent to each other, the movable insert 6 may be configured in such a manner that two adjacent surfaces thereof are opposite to the fixed side opening portion 12.

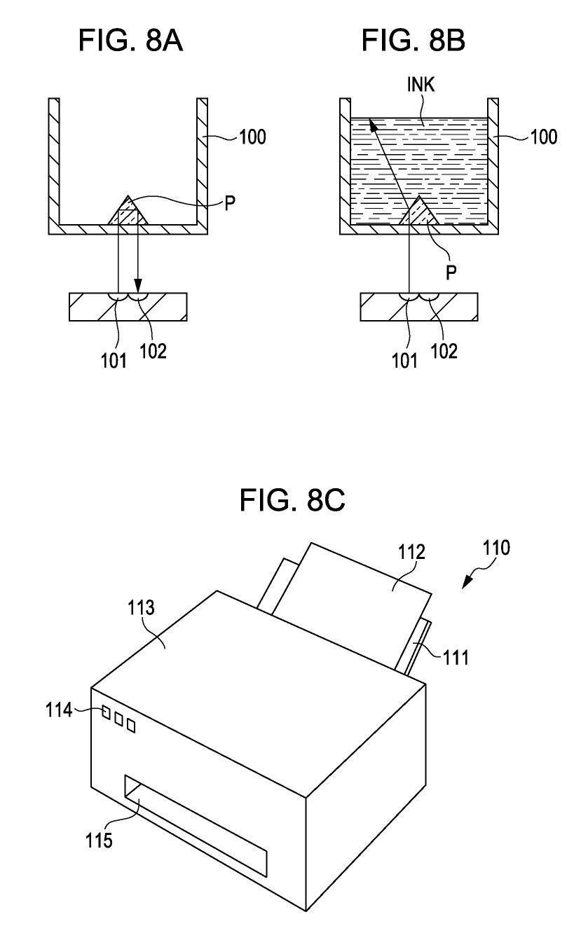

The injection-molded product P that is formed by the above-described injection molding method may be used as an optical prism P that is an optical element. FIGS. 8A and 8B show views illustrating an ink tank 100 including an optical prism P.

As shown in FIG. 8A, in a case where ink is not present in the ink tank 100, light emitted from the light emitting section 101 is refracted inside the optical prism P, and is returned to a light receiving section 102. As shown in FIG. 8B, in a case where the ink is present in the ink tank 100, the light emitted from the light emitting section 101 is transmitted through the optical prism P and is not returned to the light receiving section 102.

FIG. 8C shows an external perspective view of an ink jet printer 110 as a recording device. The ink jet printer 110 is provided with a paper support 111 on which paper P is placed as a recording medium, and an operation button 114 that performs turning on and off of power or setting of printing conditions. The ink tank 100 shown in FIGS. 8A and 8B, and a liquid ejecting head (not shown) to which the ink is supplied from the ink tank 100 and which ejects the ink are provided inside a casing 113. The ink jet printer 110 feeds the paper P placed on the paper support 111 to the inside of the casing 113, forms characters or images on the paper P using a recording head (not shown), and discharges the paper P from a discharging port 115.

In addition, an equilateral triangle is exemplified as the optical prism, but it is needless to say that the invention is applicable to general triangles.

The entire disclosure of Japanese Patent Application No.: 2011-126687, filed Jun. 6, 2011 is expressly incorporated by reference herein.

What is claimed is:

1. An injection molding method, comprising:
injecting a molten resin into a molding space, which is formed in a mold closed state, between a pair of molds including a movable insert that is mounted in at least one of the pair of molds in which mold opening and mold closing are possible;
primarily cooling the molten resin, which is injected into the molding space in the injecting of the molten resin, in a state in which a surface of the molten resin comes into contact with the movable insert to solidify the surface;
separating the movable insert from the molten resin by moving the movable insert before internal solidification of the molten resin, whose surface is solidified in a state in which the surface comes into contact with the movable insert in the primarily cooling of the molten resin, is completed; and
secondarily cooling the molten resin to complete the internal solidification in a state in which the molten resin and the movable insert are separated from each other in the separating of the movable insert.

2. The method according to claim 1,
wherein in the separating of the movable insert, the movable insert is made to move before the internal solidification of the molten resin, whose surface is solidified to a state in which an injected shape in the molding space is maintained even when the movable insert is separated, is completed.

3. An injection-molded product that is formed in accordance with the injection molding method according to claim 1.

4. The injection-molded product according to claim 3,
wherein the injection-molded product is an optical element.

5. The injection-molded product according to claim 4,
wherein the optical element is an optical prism.

6. An ink tank, comprising:
the optical prism according to claim 5.

7. A recording device, comprising:
the ink tank according to claim 6.

8. An injection-molded product, comprising:
a high quality required surface and a high quality not-required surface that has surface accuracy lower than that of the high quality required surface,
wherein the injection-molded product is formed of a solidified molten resin, and
in a case where an amount of shrinkage accompanying the solidification of the molten resin with respect to the maximum thickness of the high quality required surface is set to S1, and an amount of shrinkage accompanying the solidification of the molten resin with respect to the maximum thickness of the high quality not-required surface is set to S2, a conditional expression of S1≦S2/2 is satisfied.

9. An injection-molded product that is formed in accordance with the injection molding method according to claim 2.

10. The injection-molded product according to claim 8,
wherein the injection-molded product is an optical element.

11. The injection-molded product according to claim 9,
wherein the optical element is an optical prism.

12. An ink tank, comprising:
the optical prism according to claim 10.

13. A recording device, comprising:
the ink tank according to claim 11.

14. An injection mold, comprising:
a movable insert that is mounted in at least one of a pair of molds in which mold opening and mold closing are possible;
a molding space forming section that forms a molding space, which is formed between the pair of molds including the movable insert in the mold closed state and into which a molten resin is injected; and
an insert driving section that moves the movable insert before internal solidification of the molten resin, which is injected into the molding space and whose surface is solidified in a state in which the molten resin comes into contact with the movable insert, is completed, and separates the molten resin whose internal solidification is not completed and the movable insert from each other until the internal solidification of the molten resin is completed.

15. The injection mold according to claim 13,
wherein the insert driving section moves the movable insert before the internal solidification of the molten resin, whose surface is solidified to a state in which an injected shape in the molding space is maintained even when the movable insert is separated, is completed.
